(19) United States
(12) Patent Application Publication
(10) Pub. No.: US 2005/0053500 A1
(43) Pub. Date: Mar. 10, 2005

(54) Vibration absorbing devices for fuel pumps

(75) Inventors: Nobuo Suzuki, Aichi-ken (JP); Tetsuya Hara, Aichi-ken (JP)

Correspondence Address: DENNISON, SCHULTZ, DOUGHERTY & MACDONALD, 1727 KING STREET, SUITE 105, ALEXANDRIA, VA, 22314, US

(73) Assignee: Aisan Kogyo Kabushiki Kaisha

(21) Appl. No.: 10/935,718

(22) Filed: Sep. 8, 2004

(30) Foreign Application Priority Data
Sep. 10, 2003 (JP) 2003-318219

(51) Int. Cl. F02M 3/00; F02D 41/00

(52) U.S. Cl. 417/423.15; 417/423.1; 417/423.3; 417/424.1

(57) ABSTRACT

A vibration absorbing device is disposed between a fuel tank and a fuel pump of a fuel delivery system. The vibration absorbing device includes a first member fixed in position relative to the fuel pump, a second member fixed in position relative to the fuel tank, and a plurality of vibration absorbing members. The vibration absorbing members are provided on one of the first and second members and resiliently slidably contact with the other of the first and second members.

With this type of recent arrangement, opposite ends of each joint portion 102 are respectively connected to the filter case 100 and the annular portion 101, so that each joint portion 102 is held to extend between the filter case 100 and the annular portion 101 in a straddling manner. However, with this type of arrangement, vibrations that may be produced during the operation of the fuel pump 104 may be readily transmitted to the fuel tank via the annular portion 101, the joint portions 102, and the filter case 100.

In addition, the joint portions 102 extend from the annular portion 101 to the filter case 100 in a direction opposite to the rotational direction (indicated by an arrow Y in FIG. 11) of the armature of the motor of the fuel pump 104. Therefore, the inertial force produced by rotation of the armature may apply thrust to the joint portions 102. As a result, the joint portions 102 held in a straddling manner may not effectively reduce the vibrations produced by the fuel pump 104.

### SUMMARY OF THE INVENTION

It is accordingly an object of the present invention to teach improved techniques for effectively absorbing vibrations produced by fuel pumps.

According to one aspect of the present teachings, vibration absorbing devices are taught that are disposed between the fuel tank and the fuel pump of a fuel delivery system. The vibration absorbing device includes a first member fixed in position relative to the fuel pump, a second member fixed in position relative to the fuel tank, and at least one vibration absorbing member. The at least one vibration absorbing member is provided on one of the first and second members and resiliently slidably contacts with the other of the first and second members.

Due to the resiliency of the at least one vibration absorbing member, vibrations that may be produced during the operation of the fuel pump can be effectively reduced or dampened. In other words, the energy of the vibration can be reduced or dissipated. In addition, because the at least one vibration absorbing member slidably contacts with the other of the first and second members, the at least one vibration absorbing member can slide relative to and along the other of the first and second members. Therefore, undesired transmission of movement of the first member to the second member can be reliably inhibited or minimized. This may further reduce the transmission of vibration energy to the second member.

In another aspect of the present teachings, the at least one vibration absorbing member is formed integrally with one of the first and second members and is preferably made of resin.

In another aspect of the present teachings, the at least one vibration absorbing member has a first end fixed to one of the first and second members and a second end slidably contacting with the other of the first and second members so as to have the vibration absorbing member be supported in a cantilever manner. Therefore, the vibration absorbing member has a relatively simple construction.

In another aspect of the present teachings, the fuel pump has a rotational axis and tends to slightly rotate in one direction due to an inertia force during operation (an inertia rotation direction). The at least one vibration absorbing member is oriented such that the first end and the second end of the at least one vibration absorbing member are displaced from each other in the direction of the inertia force. Therefore, the second end of the vibration absorbing member can smoothly slide along the other of the first and second members in response to the movement of the first member in the direction of the inertia force while reliably maintaining a contacting relationship therewith.

Preferably, the first member has a substantially cylindrical outer wall and the second member has a substantially cylindrical inner wall about the rotational axis of the motor. The at least one vibration absorbing portion is also preferably disposed between the outer wall of the first member and the inner wall of the second member.

Preferably, a plurality of vibration absorbing portions is provided. Each vibration absorbing portion is preferably spaced apart from each other in a circumferential direction.

The first end of the at least one vibration absorbing member may be fixed to the outer wall of the first member. The second end of the at least one vibration absorbing member may slidably contact with the inner wall of the second member at a position displaced from the first end in a direction opposite to the direction of the inertia force.

Alternatively, the first end of the at least one vibration absorbing member may be fixed to the inner wall of the second member. The second end of the at least one vibration absorbing member may slidably contact with the outer wall of the first member at a position displaced from the first end in the direction of the inertia force.

In another aspect of the present teachings, the at least one vibration absorbing member has a bent portion turned back upon itself in a position between the first and second ends in order to enhance the resiliency in the radial direction of the fuel pump. Therefore, the vibration of the fuel pump can be effectively reduced with respect to the radial direction.

In another aspect of the present teachings, the first member is a first tubular member fixedly attached to the fuel pump, the second member is a second tubular member fixedly attached to the fuel tank, and the at least one vibration absorbing member is disposed within a space defined between the first and second tubular members. Therefore, the vibration absorbing device may have a relatively compact configuration.

In another aspect of the present teachings, the fuel delivery system further includes a first filter for filtering the fuel drawn into the fuel pump. The first tubular member is a filter support for supporting the first filter. Therefore, an existing filter support can be used as the first member of the vibration absorbing device.

In another aspect of the present teachings, the fuel delivery system further includes a second filter for filtering the fuel discharged from the fuel pump. The second tubular member is a filter case for receiving the second filter. Therefore, an existing filter case can be used as the second member of the vibration absorbing device.

In another aspect of the present teachings, the vibration absorbing device further includes an adapter connecting the fuel tank to the second member. The adapter is made of a resilient member, so that the second member resiliently supports the fuel tank. Therefore, the vibration of the fuel pump can be further effectively reduced.

### BRIEF DESCRIPTION OF THE DRAWINGS

FIG. 1 is a vertical sectional view of a fuel delivery system incorporating a first representative vibration absorbing device; and

FIG. 2 is a horizontal sectional view taken along line II-II in FIG. 1; and

FIG. 3 is a horizontal sectional view similar to FIG. 2 but showing a second representative vibration absorbing device; and

FIG. 4 is a vertical sectional view of a fuel delivery system incorporating a third representative vibration absorbing device; and

FIG. 5 is a vertical sectional view of a fuel delivery system incorporating a fourth representative vibration absorbing device; and

FIG. 6 is a horizontal sectional view similar to FIG. 2 but showing a fifth representative vibration absorbing device; and

FIG. 7 is a horizontal sectional view similar to FIG. 2 but showing a sixth representative vibration absorbing device; and

FIG. 8 is a horizontal sectional view similar to FIG. 2 but showing a seventh representative vibration absorbing device; and

FIG. 9 is a horizontal sectional view similar to FIG. 2 but showing an eighth representative vibration absorbing device; and

FIG. 10 is a vertical sectional view of a fuel delivery system incorporating a ninth representative vibration absorbing device; and

FIG. 11 is horizontal sectional view of a known vibration absorbing device.

### DETAILED DESCRIPTION OF THE INVENTION

Each of the additional features and teachings disclosed above and below may be utilized separately or in conjunction with other features and teachings to provide improved methods and devices for reducing vibrations of fuel pumps. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

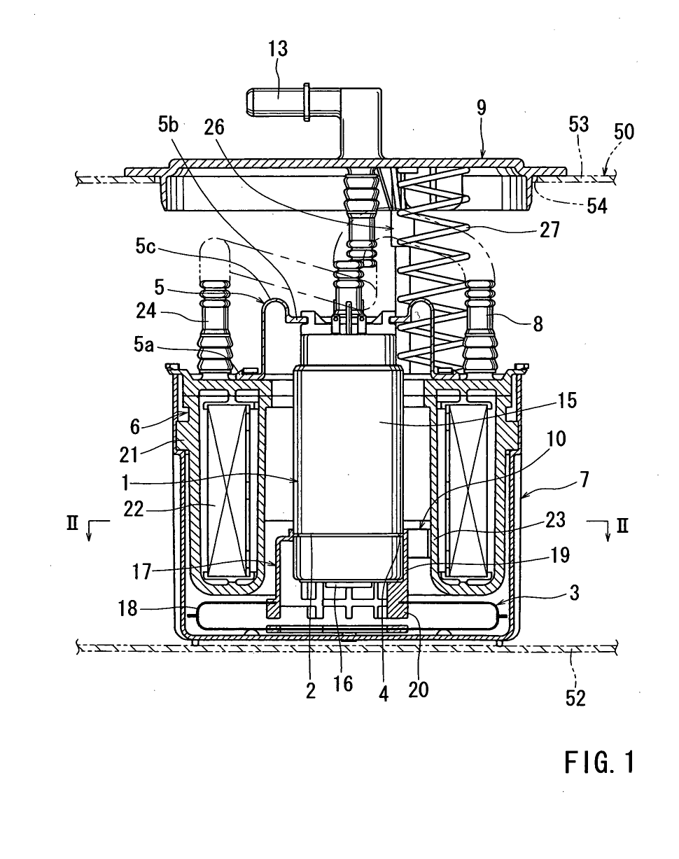

Various representative embodiments of the present invention will now be described with reference to FIGS. 1 to 10.

First Representative Embodiment

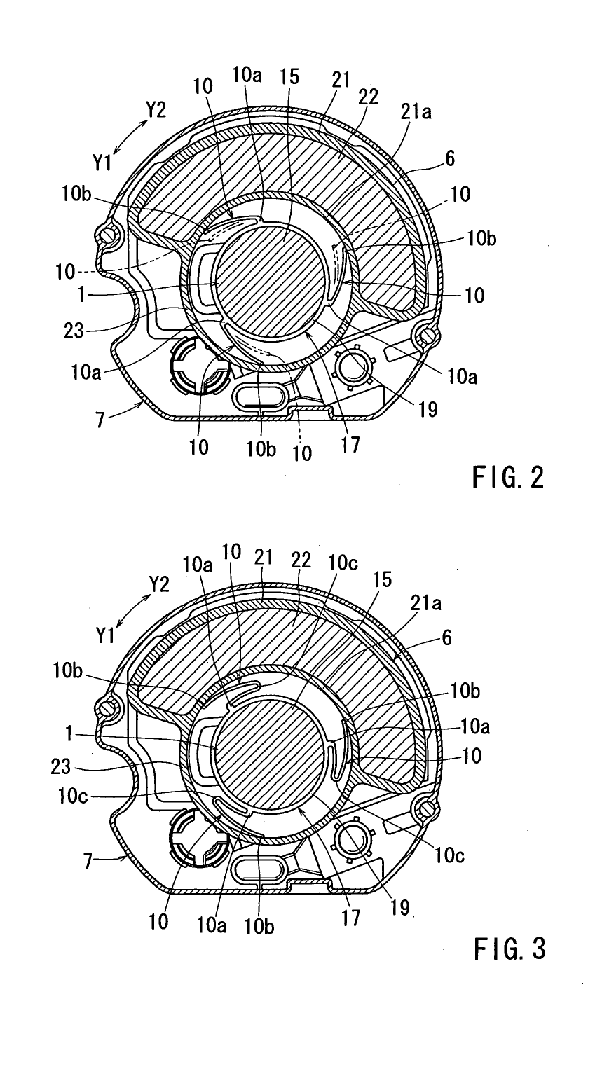

Referring to FIGS. 1 and 2, a first representative device for absorbing vibrations produced by a fuel pump is shown. The first representative device is applied to a fuel delivery system that is configured as a module including a fuel filter, a reservoir cup, and a flange, etc. Therefore, the fuel delivery system will be first described and thereafter the first representative device will be described. The fuel delivery system is assembled within a fuel tank 50. The fuel tank 50 defines a substantially sealed space for storing fuel. The fuel tank 50 has a bottom plate 52, a top plate 53, and a sidewall (not shown). An opening 54 is formed in the top plate 53.

As shown in FIG. 1, the fuel delivery system includes a fuel pump 1, a fuel filter 6, a reservoir cup 7, and a flange 9. For convenience of explanation, these elements will be described in the order of the reservoir cup 7, the flange 9, the fuel pump 1, and the fuel filter 6.

The reservoir cup 7 is substantially configured in a cup-shape with an upper opening and is placed on the bottom plate 52 of the fuel tank 50. The flange 9 is secured to the upper surface of the upper plate 53 in order to sealingly close the opening 54 formed in the upper plate 53. A fuel discharge pipe 13 is attached to the flange 9 so as to extend between the interior (inside) and exterior (outside) of the fuel tank 50 through the flange 9. The outside end of the fuel discharge pipe 13 is adapted to be connected to an engine, such as an internal combustion engine of an automobile, via a fuel delivery pipe (not shown).

The fuel pump 1 is configured as an electrically driven pump and is disposed within the reservoir cup 7 along with the fuel filter 6. The fuel pump 1 has a substantially cylindrical pump body 15, a pump section (not shown) assembled within the lower portion of the pump body 15, and a motor section (also not shown) assembled within the pump body 15 in a position above the pump section. In addition, the pump body 15 has a suction port 16 positioned at the lower end of the pump body 15, so that the fuel within the reservoir cup 7 can be drawn into the pump body 15 via the suction port 16. Further, the pump body 15 has a discharge port (not shown) at the upper end of the pump body 15, so that the fuel can be discharged upward from the pump body 15 via the discharge port.

A suction filter 3 is attached to the lower end of the pump body 15 so as to substantially enclose the lower end of the pump body 15. The suction filter 3 has a fitting member 17 and a bag-shaped mesh filter element 18 integrated with the fitting member 17. The fitting member 17 is made of synthetic resin and is fitted onto the lower end of the pump body 15. The fitting member 17 has a substantially cylindrical tubular portion 19 and a filter attaching portion 20 formed in series with the lower end of the tubular portion 19. An annular projection 4 is formed on an inner peripheral surface of the tubular portion 19 and extends along the circumferential direction of the tubular portion 19. An annular recess 2, corresponding to the annular projection 4, is formed in an outer peripheral surface of the pump body 15.

The tubular portion 19 of the fitting member 17 is fitted onto the lower end of the pump body 15, such that the annular projection 4 of the tubular portion 19 is press-fitted into the annular recess 2 of the pump body 15. In this way, the suction filter 3 is attached to the pump body 15. The mesh filter element 18 is flattened in the horizontal direction and has an opening in an upper portion. The filter attaching portion 20 is joined to the peripheral edge of the upper opening of the filter element 18.

As shown in FIG. 2, the fuel filter 6 has a substantially C-shaped filter case 21 that encloses the fuel pump 1. A filter element 22 is disposed within the filter case 21. Although not shown in the drawings, the filter case 21 has a fuel inlet port and a fuel outlet port. The fuel inlet port of the filter case 21 is connected to the discharge port of the fuel pump 1 via a first pipe 8. The fuel outlet port of the filter case 21 is connected to the fuel discharge pipe 13 of the flange 9 via a second pipe 24. Each of the first and second pipes, 8 and 24, is configured as a flexible pipe. For example, each of the first and second pipes, 8 and 24, may be made of rubber or any other elastic resin material. Alternatively, each of the first and second pipes, 8 and 24, may be a bellows pipe made of metal or resin. Because the fuel filter 6 is disposed on the high-pressure output side of the fuel pump 1, opposite to the lower pressure input side containing the suction filter 3, fuel filter 6 is generally called a “high-pressure filter.”

As shown in FIG. 2, the filter case 21 has an inner circumferential wall 21a and a substantially cylindrical tubular portion 23 that are formed integrally with each other. The tubular portion 23 encloses the fuel pump 1 such that a predetermined gap is formed between the tubular portion 23 and the fuel pump 1. The tubular portion 23 has a central axis that coincides with the central axis of the tubular portion 19 of the fitting member 17.

As shown in FIG. 1, the filter case 21 is fitted into the reservoir cup 7 via a snap-fit mechanism or any other type of suitable fitting mechanism. In the fitted position shown in FIG. 1, the lower surface of the mesh filter element 18 of the suction filter 3 may contact the bottom of the reservoir cup 7 or may be spaced a slight distance apart from the bottom of the reservoir cup 7.

The reservoir cup 7 is joined to the flange 9 via a joint device 26. The joint device 26 permits adjustment of the vertical position of the reservoir cup 7 relative to the flange 9. In addition, a spring 27 is interposed between the reservoir cup 7 and the flange 9 in order to urge the reservoir cup 7 toward the bottom plate 52 of the fuel tank 50.

In operation of the fuel delivery system, when the fuel pump 1 is driven the fuel within the reservoir cup 7 is drawn into the fuel pump 1 via the suction filter 3. The fuel is then discharged from the fuel pump 1 via the discharge port and is delivered to the fuel filter 6 via the first pipe 8. The fuel may be filtered by flowing through the fuel filter 6. The fuel is further delivered to the engine via the second pipe 24, the fuel discharge pipe 13 of the flange 9, and the fuel delivery pipe (not shown).

The device for absorbing vibrations of the fuel pump 1 will now be described. This device is provided between the tubular portion 19 of the fitting member 17 and the tubular portion 23 of the filter case 21 of the fuel filter 6. Thus, as shown in FIG. 2, a suitable number of vibration reducing portions 10 (three vibration reducing portions 10 are provided in this representative embodiment) are formed integrally with the outer peripheral surface of the tubular portion 19 of the fitting member 17 and are spaced apart from each other by a suitable distance in the circumferential direction. Each of the vibration reducing portions 10 has a strip-like configuration and has a width in the vertical direction as viewed in FIG. 1. Also, each of the vibration reducing portions 10 extends from the tubular portion 19 in a cantilever manner. In addition, each of the vibration reducing portions 10 naturally has flexibility and may be bent about its base end, or in other words, about its first end 10a joined to the tubular portion 19, as indicated by the broken lines in FIG. 2. Further, each of the vibration reducing portions 10 is inclined in such a manner that the free end of the second end 10b is displaced from the first end 10a in the rotational direction (indicated by an arrow Y1 in FIG. 2) of the armature (not shown) of the motor section of the fuel pump 1. The free second end 10b resiliently and slidably contacts with the inner peripheral surface of the tubular portion 23 of the filter case 21. In this way, the vibration reducing portions 10 are provided between the filter case 21 and the fitting member 17. The filter case 21 and the fitting member 17 are respectively fixed in position relative to the fuel tank 50 and the fuel pump 1.

As shown in FIG. 1, an adapter 5 made of resin is mounted on the upper end of the filter case 21 of the fuel filter 6 in order to resiliently support the fuel pump 1 with respect to the filter case 21. The adapter 5 has a substantially annular base portion 5a, a substantially annular mount 5b having a smaller size than the base portion 5a, and a resiliently deformable portion 5c connecting the base portion 5a and the mount 5b. The base portion 5a may be fixed onto the upper surface of the filter case 21 by a snap-fit mechanism or any other suitable fixing mechanism. Also, the mount 5b is fixed onto the upper end surface of the pump body 15 of the fuel pump 1 by a snap-fit fit mechanism or any other suitable fixing mechanism. The resiliently deformable portion 5c is connected to the mount 5b via an upwardly oriented curved end that provides resiliency to the resiliently deformable portion 5c, so that the fuel pump 1 is resiliently supported with respect to the circumferential direction, the diametrical direction, and the axial direction (vertical direction as viewed in FIG. 1). In particular, due to the configuration of the resiliently deformable portion 5c, the fuel pump 1 is facilitated to move in the axial direction.

As described above, the vibration reducing device has vibration reducing portions 10 that are formed integrally with the tubular portion 19 of the fitting member 17 of the suction filter 3. The vibration reducing portions 10 are resiliently flexible; so that the free second ends 10b slidably contact the tubular portion 23 of the filter case 21 of the fuel filter 6.

Therefore, the vibration reducing portions 10 may have the following functions:

(1) Due to the flexibility of the vibration reducing portions 10, it is possible to reduce the vibrations of the fuel pump 1, in particular the vibrations in the diametrical direction, which may be produced when the fuel pump 1 is operated.

(2) When the fuel pump 1 is operated to rotate the armature of the motor section, an inertia force is applied to the pump body 15 in the direction (the direction indicated by an arrow Y2 in FIG. 2) opposite to the rotational direction of the armature (the direction indicated by an arrow Y1 in FIG. 2). When this occurs, the vibration reducing portions 10 move in the circumferential direction while maintaining slide contact with the tubular portion 23 of the filter case 21 of the fuel filter 6. Therefore, it is possible to prevent or minimize the transmission of the inertia force to the filter case 21.

The functions (1) and (2) synergistically contribute to effectively reducing the vibrations of the fuel pump 1.

In addition, each of the vibration absorbing portions 10 extends from the tubular portion 19 of the fitting member 17 of the suction filter 3 in a cantilever manner. Further, each of the vibration absorbing portions 10 is inclined such that the free second end 10b is displaced from the base first end 10a in the rotational direction (the direction as indicated by an arrow Y1 in FIG. 2) of the armature of the fuel pump 1. Therefore, as the pump body 15 rotates in the direction indicated by an arrow Y2 in FIG. 2 due to the inertia force, the vibration absorbing portions 10 can move relative to the filter case 21 of the fuel filter 6 with their free second ends 10b slidably contacting the tubular portion 23 of the fuel filter 6.

Furthermore, the tubular portion 23 of the filter case 21, made of synthetic resin, and the tubular portion 19 of the fitting member 17, also made of synthetic resin, have essentially coincident central axes and the vibration reducing portions 10 are formed integrally with the tubular portion 19 of the fitting member 17. Therefore, the vibration reducing portions 10 may be positioned within a relatively compact space defined between the tubular portion 23 and the tubular portion 19. In addition, because the free second ends 10b of the vibration absorbing portions 10, made of synthetic resin, slidably contact with the resin tubular portion 23, frictional resistance between the free second ends 10b and the tubular portion 23 can be effectively reduced or minimized.

In the meantime, the fuel pump 1 is resiliently supported by the filter case 21 of the fuel filter 6 via the adapter 5. Therefore, vibrations of the fuel pump 1 can also be absorbed by the resiliency of the adapter 5. In particular, the vibrations of the fuel pump in the axial direction (the vertical direction as viewed in FIG. 1) can be effectively absorbed by the resiliently deformable portion 5c.

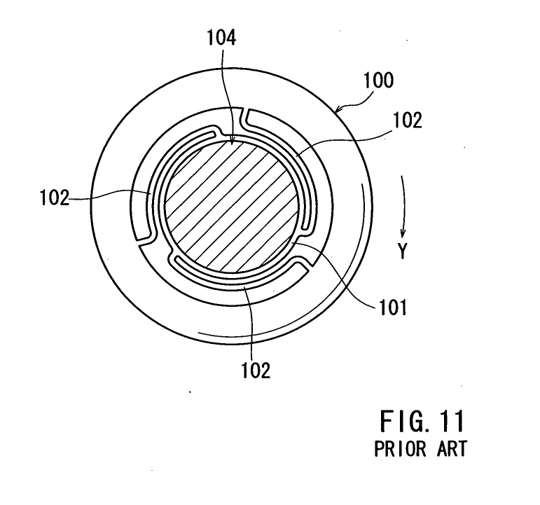

The inventors of the present invention have carried out experiments to determine a ratio corresponding to the transmission of vibrations from the fuel pump to the fuel delivery system of the first representative embodiment incorporating the vibration reducing device as described above. They have also carried out experiments to determine a ratio corresponding to the transmission of vibrations from the fuel pump to the fuel delivery system for the case of the support device of the known art shown in FIG. 11. Here, the vibration transmission ratio is calculated from the following expression:
V=(V₁/V₂)×100

(V: transmission ratio (%),

V₁: vibration level (G) of the fuel delivery system,

V₂: vibration level (G) of the fuel pump)

The following table shows the result of experiments:

| | Transmission ratio V (%) | | |
|---|---|---|---|
| | Rotational | | |
| | Direction | Radial direction | Axial direction |
| | of the Armature | of the Armature | of the Armature |
| Known Art - | 7.7 | 55.6 | 52.5 |
| First | 1.1 | 2.3 | 11.0 |
| Representative | | | |
| Embodiment | | | |

As a result, it has been shown that according to the first representative embodiment, the vibration transmission ratio can be reduced with respect to the rotational direction, the radial direction, and the axial direction of the armature in comparison with the known art shown in FIG. 11.

Second to eighth representative fuel delivery systems will now be described with reference to FIGS. 3 through 10. The second to eighth representative embodiments are modification of the first representative embodiment. Therefore, in FIGS. 3 to 10, like members are given the same reference numerals as FIGS. 1 and 2, and the description of these members will not be repeated.

Second Representative Embodiment

As shown in FIG. 3, according to the second representative embodiment, each of the vibration absorbing portions 10 has a substantially U-shaped bent part 10c that is turned back upon itself at substantially the middle position between the base first end 10a and the free second end 10b. Therefore, the vibration absorbing portions 10 are able to deform in the radial direction of the armature of the fuel pump 1. As a result, the vibration absorbing portions 10 can effectively reduce the vibrations of the fuel pump 1 in the radial direction of the armature.

Third Representative Embodiment

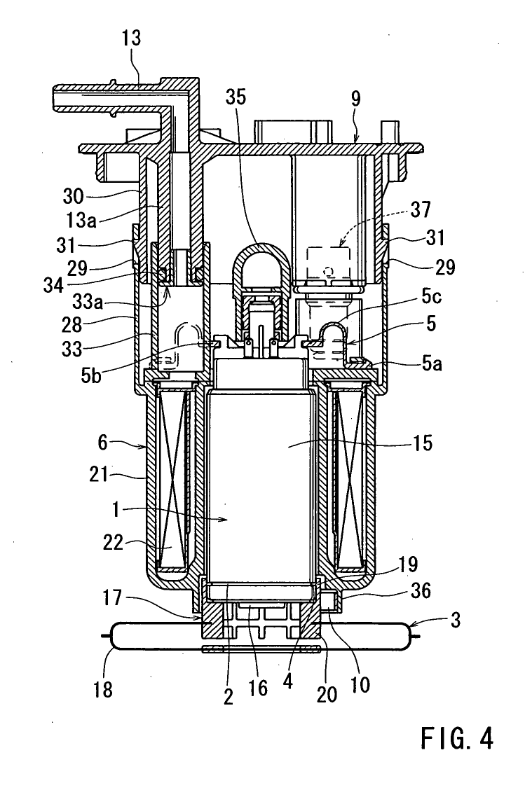

As shown in FIG. 4, the fuel delivery system according to the third representative embodiment does not include the reservoir cup 7 that is provided in the first representative embodiment. In this connection, the filter case 21 of the fuel filter 6 and the flange 9 are connected to one another in a different manner than the first representative embodiment. The joint device 26, the spring 27, and the second pipe 24, are omitted in the third representative embodiment.

As shown in FIG. 4, an outer sleeve 28 is formed integrally with the filter case 21 and extends vertically upward from the upper end of the outer periphery of the filter case 21. On the other hand, an inner sleeve 30 is formed integrally with the flange 9 and extends vertically downward from the lower surface of the flange 9 so as to be fitted into the outer sleeve 28. A suitable number of engaging holes 29 are formed in the upper portion of the outer sleeve 28 in order to engage corresponding engaging projections 31 formed on an outer wall of the lower portion of the inner sleeve 30. The filter case 21 has a fuel outlet port 33 that receives a lower portion 13a of the fuel discharge pipe 13 of the flange 9 and is joined thereto via a socket and spigot joint 33a.

In this way, the filter case 21 is connected to the flange 9 by fitting the inner sleeve 30 of the flange 9 into the outer sleeve 28 of the filter case 21 with the engaging projections 31 of the inner sleeve 30 engaged with the engaging holes 29 of the outer sleeve 28. At the same time, the fuel outlet 33 of the filter case 21 and the fuel discharge pipe 13 of the flange 9 are joined to each other via the socket and spigot joint 33a. An O-ring 34 is attached to the fuel discharge pipe 13 in order to seal between the fuel discharge pipe 13 and the fuel outlet 33. In addition, in this third representative embodiment a pipe 35, corresponding to the first pipe 8 of the first representative embodiment, is configured as a rigid pipe made of resin or metal, although the pipe 35 may be a flexible pipe made of elastomeric material such as rubber or may be a bellows pipe made of metal or resin.

A substantially cylindrical tubular extension 36 is formed integrally with the lower end of the filter case 21 of the fuel filter 6. The free second ends of the vibration absorbing portions 10 of the vibration absorbing device slidably contact the inner peripheral surface of the tubular extension 36. In this connection, the vibration absorbing portions 10 extend from a part of the outer peripheral surface of the fitting member 17. The vibration absorbing portions 10 are located between the tubular portion 19 and the filter attaching portion 20 of the fitting member 17. A pressure regulator 37 is mounted on the filter case 21 in order to regulate the fuel pressure within the filter case 21 to below a predetermined pressure.

Fourth Representative Embodiment

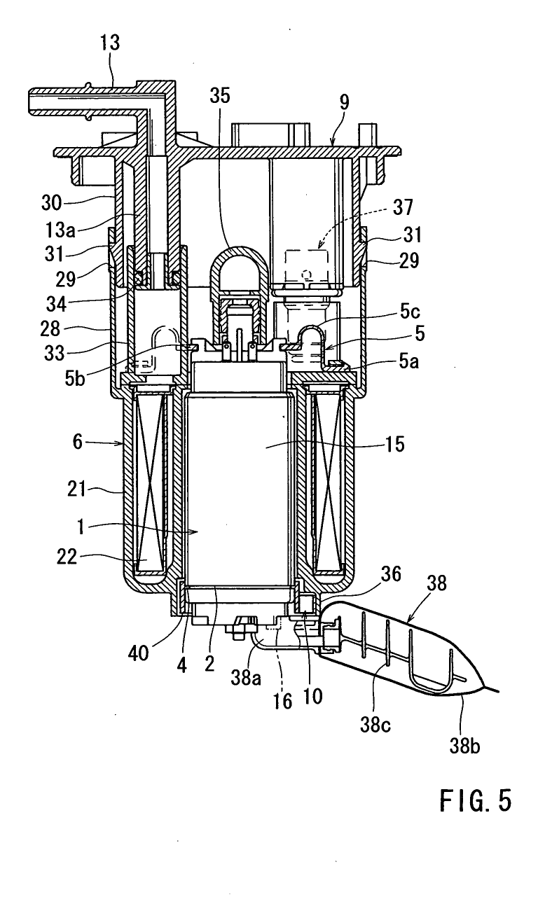

The fourth representative embodiment will now be described with reference to FIG. 5. The fourth representative embodiment is a modification of the third representative embodiment and is different from the third representative embodiment in that a suction filter 38, connected to the suction port 16 of the fuel pump 1, is incorporated in place of the suction filter 3 of the first representative embodiment shown in FIG. 4. The suction filter 38 includes a fitting member 38a, a bag-shaped mesh filter element 38b, and a framework 38c. The fitting member 38a is made of resin and is fitted onto the suction port 16 of the pump body 15. The filter element 38b is formed integrally with the fitting member 38a. The framework 38c is also integrally formed with the fitting member 38 a and serves to maintain the filter element 38b in an expanded configuration.

In addition, in the fourth representative embodiment, a cylindrical tubular member 40, that is a separate member from the suction filter 38, is fitted onto the lower end of the pump body 15 of fuel pump 1 in a manner similar to the tubular portion 19 of the suction filter 3 of the first representative embodiment. The vibration absorbing portions 10 are formed integrally with the tubular member 40 and extend from the outer peripheral surface of the tubular member 40.

Fifth Representative Embodiment

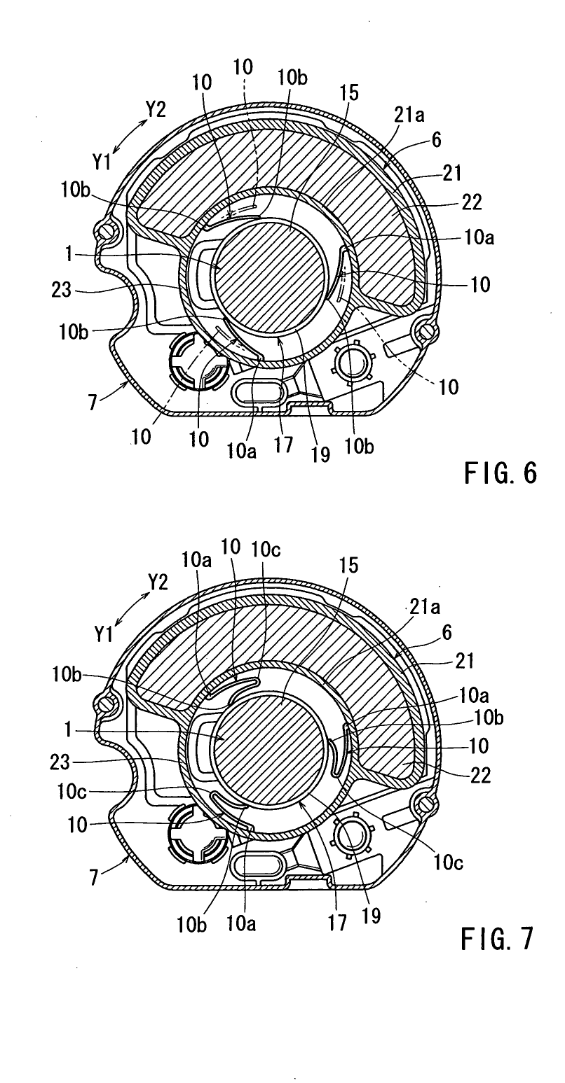

The fifth representative embodiment shown in FIG. 6 is a modification of the first representative embodiment and is different from the first representative embodiment in that the vibration absorbing portions 10 are formed integrally with the tubular portion 23 of the filter case 21. Therefore, the free second ends 10b of the vibration absorbing portions 10 slidably contact the outer peripheral surface of the tubular portion 19 of the fitting member 17.

Sixth Representative Embodiment

The sixth representative embodiment shown in FIG. 7 is a modification of the second representative embodiment shown in FIG. 3 and is different from the second representative embodiment in that the vibration absorbing portions 10 are formed integrally with the tubular portion 23 of the filter case 21. Therefore, the free second ends 10b of the vibration absorbing portions 10 slidably contact with the outer peripheral surface of the tubular portion 19 of the fitting member 17.

Seventh Representative Embodiment

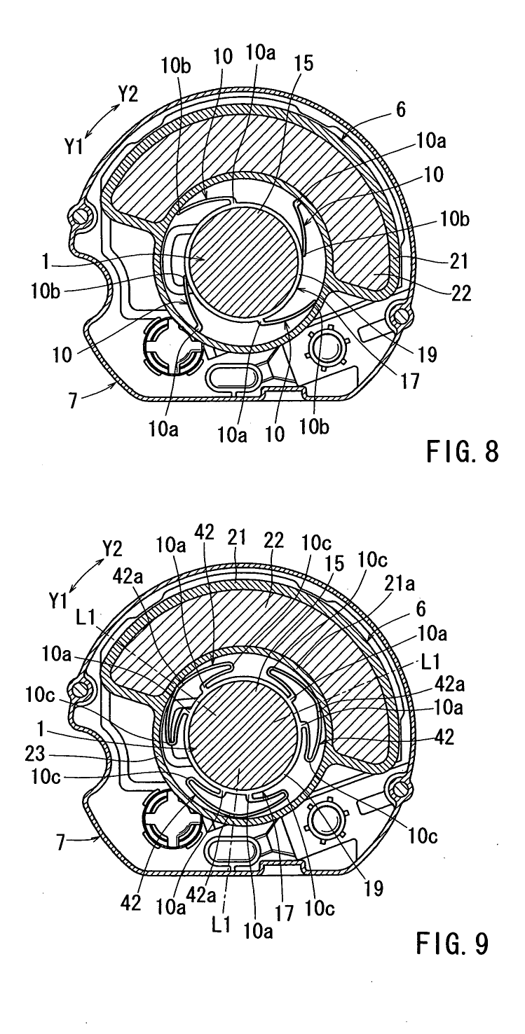

The seventh representative embodiment shown in FIG. 8 is a modification corresponding to the first representative embodiment combined with the fifth embodiment shown in FIG. 6. Thus in this representative embodiment, some vibration absorbing portions 10 are formed integrally with the tubular portion 19 of the fitting member 17, and some vibration absorbing portions 10 are formed integrally with the tubular portion 23 of the filter case 21. The vibration absorbing portions 10 are arranged alternately in the circumferential direction.

Eighth Representative Embodiment

The eighth representative embodiment shown in FIG. 9 is another modification of the second representative embodiment and is different from the second representative embodiment in that the vibration absorbing portions 10 are formed in pairs (three pairs are provided in this representative embodiment). In addition, the vibration absorbing portions 10 in each pair are configured to be symmetrical with respect to a radial line L1 of either the fuel pump 1 or the tubular portion 19 of the fitting member 17. The vibration absorbing portions 10 are joined to each other at their free second ends. Therefore, each pair of vibration absorbing portions 10 form a substantially Ω-shaped vibration absorbing member 42 having an arc-shaped radial end surface 42a that slidably and resiliently contacts the inner peripheral surface of the tubular portion 23 of the filter case 21.

Ninth Representative Embodiment

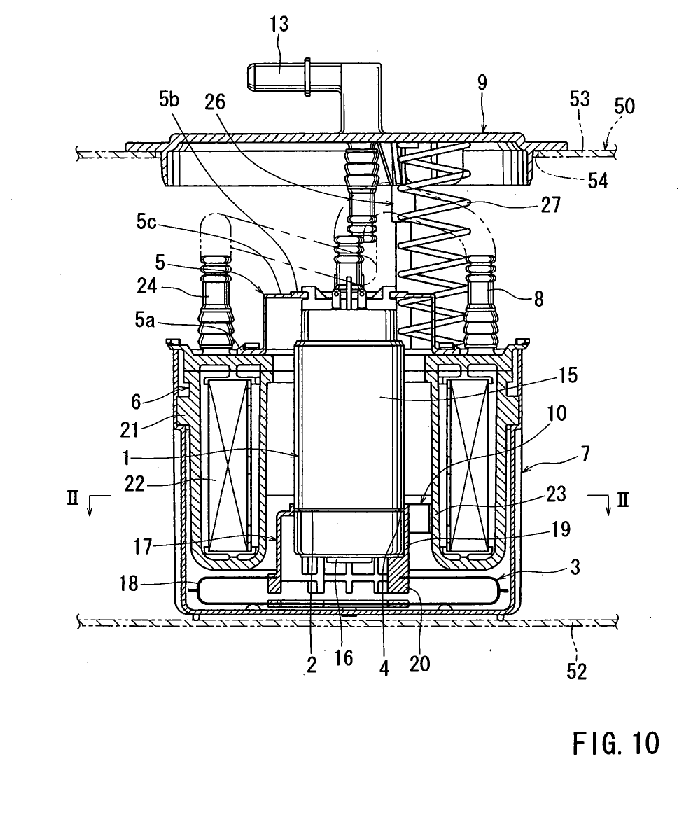

The ninth representative embodiment shown in FIG. 10 is another modification of the first representative embodiment and is different from the first representative embodiment in that the resiliently deformable portion 5c of the adapter 5 is connected to the mount 5b via an upper end that has a substantially inverted L-shaped cross section. With this configuration, the fuel pump 1 can also be resiliently supported.

(Possible Alternative Arrangements of First to Fourth Representative Embodiments)

The present invention may not be limited to the above representative embodiments but may be modified in various ways. For example, although the vibration absorbing portions 10 (and the vibration absorbing members 42) are described as being formed integrally with one of the tubular portion 19 of the fitting member 17 (attached to the fuel pump 1) and the tubular portion 23 of the filter case 21 (attached to the fuel tank 50), the vibration absorbing portions 10 (and the vibration absorbing members 42) may be formed apart from either of the tubular portions, 19 and 23. Such separate vibration absorbing portions 10 (and the vibration absorbing members 42) may be attached to the tubular portion 19 of the fitting member 17 or the tubular portion 23 of the filter case 21 by any suitable means, such as snap-fit mechanisms, adhesive, and welding.

If the separate vibration absorbing portions 10 (and the vibration absorbing members 42) and one of the tubular portions 19 and 23, to which the vibration absorbing portions 10 (and the vibration absorbing members 42) are attached, are both made of resin, preferably they may be molded together or they may be bonded to each other by heat-welding. On the other hand, if the separate vibration absorbing portions 10 (and the vibration absorbing members 42) and one of the tubular portions 19 and 23, to which the vibration absorbing portions 10 (and the vibration absorbing members 42) are attached, are both made of metal, they may be bonded to each other by welding.

If the separate vibration absorbing portions 10 (and the vibration absorbing members 42) and one of the tubular portions 19 and 23, to which the vibration absorbing portions 10 (and the vibration absorbing members 42) are attached, are made of different materials from one another, the vibration absorbing portions 10 (and the vibration absorbing members 42) may be attached to the tubular portions 19 or 23 by snap-fit mechanisms or by fastening means such as screws.

Further, in case where the vibration absorbing portions 10 are formed or attached to the sleeve 23 of the filter case 21 on the side of the fuel tank 50, the free second ends 10b of the vibration absorbing portions 10 may directly contact the outer peripheral surface of the pump body 15. In this way, the vibration absorbing portions 10 (absorbing member 42) may be disposed at any place where a member, such as the filter case 21 mounted to the fuel tank 50, opposes the fuel pump 1 or any intermediate member mounted to the fuel pump 1.

Furthermore, although the suction filter 3 (38) in the above representative embodiments is made of resin, the suction filter 3 may be made of metal mesh. In addition, although the adapter 5 is made of resin, the adapter 5 may be made of any other material, such as metal spring plate, as long as the adapter 5 can resiliently support the fuel pump 1.

1. A vibration absorbing device disposed between a fuel tank and a fuel pump of a fuel delivery system, the vibration absorbing device comprising:
a first member fixed in position relative to the fuel pump; and
a second member fixed in position relative to the fuel tank; and
at least one vibration absorbing member provided on one of the first and second members and resiliently slidably contacting the other of the first and second members.

2. The vibration absorbing device as in claim 1, wherein the at least one vibration absorbing member is formed integrally with one of the first and second members.

3. The vibration absorbing device as in claim 2, wherein the at least one vibration absorbing member and one of the first and second members are made of resin.

4. The vibration absorbing device as in claim 1, wherein the at least one vibration absorbing member comprises:
a first end fixed to one of the first and second members, and
a second end slidably contacting with the other of the first and second members, and
wherein the at least one vibration absorbing member is supported in a cantilever manner.

5. The vibration absorbing device as in claim 4, wherein:
the fuel pump has a rotational axis and tends to rotate in one direction due to an inertia force during operation; and
the at least one vibration absorbing member is oriented such that the first end and the second end of the at least one vibration absorbing member are displaced from each other in the direction of the inertia force.

6. The vibration absorbing device as in claim 5, wherein:
the first member has a substantially cylindrical outer wall about the rotational axis of the pump, and
the second member has a substantially cylindrical inner wall about the rotational axis of the pump, and
at least a portion of the substantially cylindrical outer wall of the first member opposes at least a portion of the substantially cylindrical inner wall of the second member, and
the at least one vibration absorbing member is disposed between the outer wall of the first member and the inner wall of the second member.

7. The vibration absorbing device as in claim 6, wherein a plurality of vibration absorbing members are provided and each vibration absorbing member is spaced apart from each other in a circumferential direction.

8. The vibration absorbing device as in claim 6, wherein:
the first end of the at least one vibration absorbing member is fixed to the outer wall of the first member; and
the second end of the at least one vibration absorbing member slidably contacts with the inner wall of the second member in a position displaced from the first end in a circumferential direction opposite to the direction of the inertia force.

9. The vibration absorbing device as in claim 6, wherein:
the first end of the at least one vibration absorbing member is fixed to the inner wall of the second member; and
the second end of the at least one vibration absorbing member slidably contacts with the outer wall of the first member in a position displaced from the first end in the circumferential direction of the inertia force.

10. The vibration absorbing device as in claim 5, wherein the at least one vibration absorbing member has a bent portion turned back upon itself in a position between the first and second ends in order to enhance the resiliency in a radial direction of the fuel pump.

11. The vibration absorbing device as in claim 4, wherein:
the first member comprises a first tubular member fixedly attached to the fuel pump;
the second member comprises a second tubular member fixedly attached to the fuel tank; and
the at least one vibration absorbing member is disposed within a space defined between the first and second tubular members

12. The vibration absorbing device as in claim 11, wherein:
the fuel delivery system further comprises a first filter for filtering a fuel drawn into the fuel pump; and
the first tubular member comprises a filter support for supporting the first filter.

13. The vibration absorbing device as in claim 11, wherein:
the fuel delivery system further comprises a second filter for filtering a fuel discharged from the fuel pump; and
the second tubular member comprises a part of a filter case for receiving the second filter.

14. The vibration absorbing device as in claim 1, further comprising an adapter connecting the fuel pump to the second member, wherein the adapter is made of a resilient member, so that the fuel pump is resiliently supported by the second member.

15. The vibration absorbing device as in claim 1, further comprising:
at least one pair of vibration absorbing members,
wherein the free ends of the vibration absorbing members are connected together, and
wherein the at least one pair of vibration absorbing members is symmetrical about a radial line extending from an axis of rotation of the fuel pump.

16. A vibration absorbing device disposed between a fuel tank and a fuel pump of a fuel delivery system, the vibration absorbing device comprising:
a fixed member fixed in position relative to the fuel tank; and
at least one vibration absorbing member comprising:
a first end provided on the fixed member, and
a second end resiliently slidably contacting the fuel pump,
wherein the fuel pump rotates in an inertia rotation direction due to an inertia force caused by the operating of the fuel pump,
wherein the second end of the at least one vibration absorbing member is positioned apart from the first end of the at least one vibration absorbing member in the inertia rotating direction of the fuel pump.

17. The vibration absorbing device as in claim 16, wherein:
the first end of the at least one vibration absorbing member is formed integrally with the fixed member; and
wherein the at least one vibration absorbing member is supported in a cantilever manner.
